(19) United States
(12) Patent Application Publication
(10) Pub. No.: US 2002/0038526 A1
(43) Pub. Date: Apr. 4, 2002

(54) Protective device for trees and plants

(75) Inventor: Roser Garrofe Morreres, Mollerussa (ES)

Correspondence Address: YOUNG & THOMPSON, 745 SOUTH 23RD STREET 2ND FLOOR, ARLINGTON, VA, 22202

(73) Assignee: ACUDAM (ASSOCIACIO COMARCAL URGELL D'AJUDA AL MINUSVALID)

(21) Appl. No.: 09/966,601

(22) Filed: Oct. 1, 2001

(30) Foreign Application Priority Data
Sep. 29, 2000 (ES) 200002410

(51) Int. Cl. A01G 9/00

(52) U.S. Cl. 47/32.4

(57) ABSTRACT

A protective device for trees and plants, used in agricultural and tree plantings to protect the shoots of young trees or plants as they grow, composed of a sheet that is rolled onto itself and has openings through which there passes a metal bar (3) that is strong enough to be embedded in dirt. The sheet is smooth, has double-layer corrugation, or is made of mesh (1) and at its lateral ends has a series of central circular or oval openings which are preferably spaced at uniform intervals, whereby a sheet (1) is equipped with an additive that protects against ultraviolet rays.

### DESCRIPTION OF INVENTION

The object of this invention as presented in this specification consists of an “Improved Protective Device for Plants and Trees”, as used on tree or agricultural plantings to protect the shoots of young trees or plants that are in the process of growing.

It is vitally important to protect plants or trees during the initial period of their growth in order to produce strong and healthy plants and trees.

As they are growing, trees and agricultural plantings are more vulnerable to disease, inclement weather, and other factors such as the use of pesticides, which can stunt their growth or even kill them.

Today more and more effort is being put into protecting the shoots of young plants and trees in order to keep them from being damaged by the effects of pesticides or to ensure that they take up as little pesticide as possible, e.g., when they are sprayed.

To accomplish this, a novel invention has been developed that minimizes the problems that plants or trees may experience during the first years of life by protecting them against inclement weather, as well as against the above-mentioned factors.

The novel and improved protective device for plants is made of a smooth, double-layer corrugated, or mesh sheet that at its lateral ends has a series of circular or oval openings, preferably spaced at uniform intervals.

The sheet is rolled onto itself, forming a cylindrical element through whose superimposed holes there passes a metal bar that is strong enough to be embedded in dirt.

In its upper area said bar has a bend that is mainly held by the two upper ends of the sheet, thus keeping it from being dislodged by the wind or other disturbances and thereby exposing the plant or tree within.

Once the bar is planted, the protective device should be banked up with dirt in order to secure it in place.

In cases where the sheet is made of mesh, it will have reinforcements on both sides to strengthen it. The sheet will then have a rhombic shape and will be able to resist attacks by chemical agents such as solutions of strong acids and bases, as well as the attacks of microorganisms (fungi, bacteria, etc.).

The three kinds of sheets described above are preferably made of polyethylene or polypropylene, whereby in all cases they are light- and weather-resistant since they are equipped with additives that protect against ultraviolet rays, keep the resin from being broken down, and extend the life of the protective device by more than three years without degradation.

Optionally, the pre-rolled sheet can have a flared mouth, or its upper peripheral edge can be angled slightly outward in order to keep the plant from being chafed as it grows.

The novel protective device provides perfect protection for young plants and trees so as to allow them to grow properly.

It is quick and easy to mount the protective device on trees and plants, thereby improving development rates and facilitating propagation.

The protective device comes in a wide range of sizes, depending on the requirements of the grower and the type of planting.

Because of the simple way in which it can be manufactured and the simple materials employed, the protective device is very economical.

### DESCRIPTION OF THE DRAWINGS

In order to illustrate what is described above, this specification is accompanied by a sheet of drawings, which is an integral part of the specification and which shows in simplified and schematic form an embodiment that is intended for illustrative purposes only and does not limit the possible embodiments of the invention.

In these drawings, FIG. 1 shows the different sheets with which the protective device can be made.

FIG. 2 shows a perspective view of the protective device mounted with the bar rolled in a mesh sheet.

FIG. 3 shows a frontal view of the protective device with the upper flared mouth.

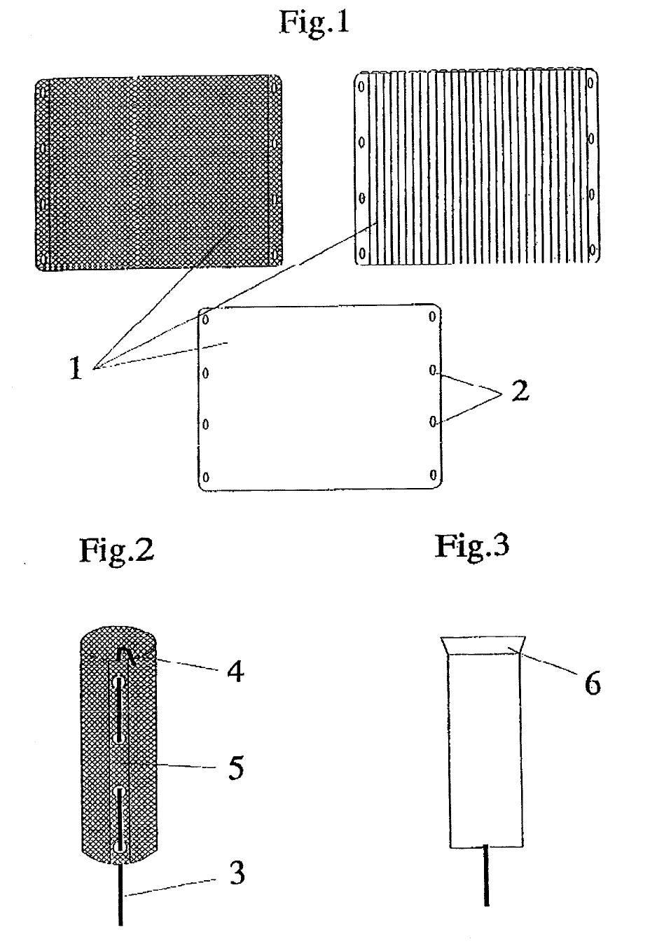

### DESCRIPTION OF AN EMBODIMENT

The novel and improved protective device for plants is produced from a smooth, double-layer corrugated, or mesh sheet (1) which at its lateral ends has a series of circular or oval openings (2), preferably spaced at uniform intervals.

The sheet is rolled onto itself, thereby forming a cylindrical element through whose superimposed openings (2) at both ends a metal bar (3) passes that is strong enough to be embedded in dirt.

In its upper area said bar has a bend (4) that is mainly held by the two upper ends of the sheet, thereby keeping it from being dislodged by the wind or other disturbances and thus exposing the plant or tree within.

Once bar (3) is planted, the protective device should be banked up with dirt in order to secure it in place.

In cases where the sheet is made of mesh, it will have reinforcements (5) on both sides to strengthen it. The sheet will then have a rhombic shape and can resist attacks by chemical agents such as solutions of strong acids and bases, as well as the attacks of microorganisms (fungi, bacteria, etc.).

The three kinds of sheets (1) described above are preferably made of polyethylene or polypropylene, which in all cases can resist light and inclement weather since they are equipped with additives that protect against ultraviolet rays, keep the resin from being broken down, and extend the life of the protective device by more than three years without degradation.

Optionally, the pre-rolled sheet can have a flared mouth, or its upper peripheral edge can be angled slightly outward (6) in order to keep the plant from being chafed as it grows.

To implement the concept state above, hereinafter is the sheet of claims, which summarizes the novel features that are to be claimed.

1. “Improved protective device for trees and plants”, of the type used in agricultural and tree plantings to protect the shoots of young trees or plants as they grow, composed of a sheet that is rolled onto itself and has openings through which there passes a metal bar (3) that is strong enough to be embedded in dirt, basically characterized by the fact that the sheet is smooth, has double-layer corrugation, or is made of mesh (1) and at its lateral ends has a series of central openings, in addition to which the openings are circular or oval (2) and are preferably spaced at uniform intervals, whereby a sheet (1) is equipped with an additive that protects against ultraviolet rays.

2. “Improved protective device for trees and plants” according to the previous claim, wherein in its upper area the bar has a bend (4) that holds the two upper ends of the sheet.

3. “Improved protective device for trees and plants” according to the previous claims, wherein, in the event that the sheet is made of mesh, said sheet has reinforcements (5) at both vertical sides that improve its strength, whereby it is designed in a rhombic shape that resist attacks by chemical agents, as well as by microorganisms (fungi, bacteria, etc.).

4. “Improved protective device for trees and plants” according to the previous claims, wherein optionally the pre-rolled sheet has a flared mouth, or the upper peripheral end is bent slightly outward (6).
